(19) United States
(12) Patent Application Publication
(10) Pub. No.: US 2018/0210001 A1
(43) Pub. Date: Jul. 26, 2018

(54) LABORATORY SAMPLE DISTRIBUTION SYSTEM AND LABORATORY AUTOMATION SYSTEM

(71) Applicant: Roche Diagnostics Operations, Inc., Indianapolis, IN (US)

(72) Inventor: Mohsin Reza, Stuttgart (DE)

(73) Assignee: Roche Diagnostics Operations, Inc., Indianapolis, IN (US)

(21) Appl. No.: 15/862,975

(22) Filed: Jan. 5, 2018

(30) Foreign Application Priority Data
Jan. 25, 2017 (EP) 17153051.2

(51) Int. Cl. G01N 35/10; G01N 35/04; B01L 9/06; G01K 13/12

(52) U.S. Cl. CPC G01N 35/10; G01N 35/04; G01N 2035/0477; G01K 13/12; B01L 9/06

(57) ABSTRACT

A laboratory sample distribution system comprising a number of optically recognizable geometric shapes placed on a transport plane or a flat template for drawing such geometric shapes is presented. A laboratory automation system comprising such a laboratory sample distribution system is also presented.

### CROSS-REFERENCE TO RELATED APPLICATIONS

This application is based on and claims priority to EP 17153051.2, filed Jan. 25, 2017, which is hereby incorporated by reference.

### BACKGROUND

The present disclosure generally relates to a laboratory sample distribution system and a laboratory automation system.

Known laboratory sample distribution systems are typically used in laboratory automation systems in order to transport samples contained in sample containers between different laboratory stations. A typical laboratory sample distribution system provides for a high throughput and for reliable operation.

It has been found out that in some cases it is desirable to have some positions marked on a transport plane of a laboratory sample distribution system.

Therefore, there is a need for a laboratory sample distribution system in which positions on a transport plane can be recognized.

### SUMMARY

According to the present disclosure, a laboratory sample distribution system is presented. The laboratory sample distribution system can comprise a transport plane, a number of sample container carriers, a driver configured to move the sample container carriers on the transport plane, and a control device configured to control the movement of the sample container carriers on top of the transport plane by driving the driver such that the sample container carriers move along corresponding transport paths. A number of optically recognizable geometric shapes are placed on the transport plane, each geometric shape representing a dedicated field on the transport plane.

In accordance with another embodiment of the present disclosure, a laboratory sample distribution system is presented. The laboratory sample distribution system can comprise a transport plane, a number of sample container carriers, a driver configured to move the sample container carriers on the transport plane, a control device configured to control the movement of the sample container carriers on top of the transport plane by driving the driver such that the sample container carriers move along corresponding transport paths, and a flat template having a plurality of holes, the holes arranged and configured for providing outlines of geometric shapes such that these geometric shapes can be drawn optically recognizably on the transport plane using the template when it is placed on the transport plane, each geometric shape drawn on the transport plane representing a dedicated field on the transport plane.

Accordingly, it is a feature of the embodiments of the present disclosure to provide for a laboratory sample distribution system in which positions on a transport plane can be recognized. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a laboratory automation system according to a first embodiment of the present disclosure.

FIG. 2 illustrates a laboratory automation system according to a second embodiment of the present disclosure.

FIG. 3 illustrates a schematic top view on a part of a laboratory sample distribution system according to the first embodiment of the present disclosure.

FIG. 4 illustrates a schematic top view on a part of a laboratory sample distribution system according to the second embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A laboratory sample distribution system is presented. The laboratory sample distribution system can comprise a transport plane, a number of sample container carriers, a driver configured to move the sample container carriers on the transport plane, and a control device configured to control the movement of the sample container carriers on top of the transport plane by driving the driver such that the sample container carriers move along corresponding transport paths.

A number of optically recognizable geometric shapes can be arranged on the transport plane, each geometric shape representing a dedicated field on the transport plane. The driver may be arranged in rows and columns forming a grid. The grid can comprise, or define, a number of fields. The optically recognizable geometric shapes may be arranged on the transport plane to visualize some or all of the fields. This can allow for a schematic visualization of the driver which may typically not be visible due to the typically opaque transport plane.

By use of the laboratory sample distribution system, fields on the transport plane can be marked with the geometric shapes in a manner that can be recognized optically. For example, the fields can be recognized by an operator and/or technically by cameras or other optical recognition systems.

The geometric shapes can be closed geometric shapes.

According to an embodiment, the geometric shapes can be directly printed on the transport plane. The term “directly printed” may imply that a certain amount of color representing the geometric shapes can be disposed directly on the transport plane. Alternatively, the geometric shapes can, for example, be directly printed on the transport plane by modifying the surface of the transport plane, for example by partially removing or roughening the transport plane, by laser texturing, by etching, or the like

According to an embodiment, the geometric shapes can be printed on a sheet covering the transport plane. The sheet can be provided separately from the transport plane and can be placed and fixed on the transport plane.

According to an embodiment, the geometric shapes can be printed on a removable cover sheet which can protect the sliding surface of the transport plane during transport and/or installation. The sliding surface can be the surface of the transport plane on which the sample container carriers move or slide. This can yield a further functionality such that the removable cover sheet providing the geometric shapes can also have a protecting function.

According to an embodiment, a first group of the geometric shapes can represent a set of input fields. For example, such input fields can be used for barcode readers, for input operations, for gripping devices or other devices needing to input sample containers on the transport plane or into sample container carriers being movably arranged on the transport plane.

According to an embodiment, a second group of the geometric shapes can represent a set of output fields. Such output fields may be used in order to remove sample containers from sample container carriers moving on the transport plane. For example, gripping devices for sending the sample containers to other entities can use such output fields as dedicated fields on the transport plane where sample containers can be handed over.

According to an embodiment, the geometric shapes of the first group can be rotated by 180° with respect to the geometric shapes of the second group. Thus, input fields and output fields can be put at different places, thus easing operation. For example, the geometric shapes of the first group may be embodied as first arrows representing input fields. The geometric shapes of the second group may be embodied as second arrows representing output fields, wherein the second arrows can be rotated by 180° with respect to the first arrows. In other words, the first arrows and the second arrows can point in opposite directions.

According to an embodiment, the geometric shapes can be positioned along a straight line adjacent to an edge of the transport plane.

A laboratory sample distribution system comprising a transport plane, a number of sample container carriers, a driver configured to move the sample container carriers on the transport plane, and a control device configured to control the movement of the sample container carriers on top of the transport plane by driving the driver such that the sample container carriers move along corresponding transport paths is presented. A flat template having a plurality of holes can be provided, the holes being shaped such that outlines of geometric shapes are provided. Thus, the geometric shapes can be drawn optically recognizably on the transport plane using the template when it is placed on the transport plane. Especially, the geometric shapes can be closed geometric shapes. Each geometric shape drawn on the transport plane can represent a dedicated field on the transport plane.

By the laboratory sample distribution system comprising such a flat template, it can be possible to provide a laboratory sample distribution system comprising a the template that can allow drawing geometric shapes on the transport plane such that an operator can define certain fields having a dedicated functionality. The flat template can be adapted to be put at dedicated places on the transport plane. The flat template can be fixed by specific fixation. Additionally, positioning and/or aligning the flat template may be provided.

According to an embodiment, the template can be made of hard paper or plastic material.

It can be noted that the flat template can have the same size as the transport plane. This can allow for easy and reliable positioning and aligning of the flat template on the transport plane.

According to an embodiment, the geometric shapes can be circles. Such circles can be easy to draw and can correspond to typically used circular shaped sample container carriers.

According to an embodiment, the driver can be formed as electro-magnetic actuators arranged below/under the transport plane in rows and columns forming a grid and controllable by the control device. The sample container carriers can each comprise a magnetically active device for interaction with the magnetic field generated by the electro-magnetic actuators such that a magnetic drive force can be applied to the sample container carriers. This can allow for easy and reliable operation of a laboratory sample distribution system, especially for driving the sample container carriers.

According to an embodiment, the geometric shapes can be positioned depending on positions of the electromagnetic actuators.

In this regard, the geometric shapes may be positioned above a center of a respective electro-magnetic actuator. A winding axis of a coil of an electro-magnetic actuator, e.g. extending substantially perpendicular to the transport plane, may define the center of the electro-magnetic actuator. The geometric shapes, e.g. in form of circles, may be arranged coaxially with the winding axis of the coil of the corresponding electromagnetic actuator. This can correspond to the fact that typically fields can be defined by respective electro-magnetic actuators. Alternatively, at least some of the geometric shapes may be positioned with a given horizontal offset (in x- and/or y-direction) with regard to the center of a respective electro-magnetic actuator. This may be useful e.g. if an external device having an own electro-magnetic actuator applying a magnetic force to a sample container carrier has to be aligned with regard to the transport plane.

According to an embodiment, the driver can be formed as wheels driven by electric motors located in the sample container carriers and controllable by the control device. This can allow for propulsion of the sample container carriers by their own drivers.

A laboratory automation system comprising a number of laboratory stations, preferably pre-analytical, analytical and/or post-analytical stations, and a laboratory sample distribution system is presented. With regard to the laboratory sample distribution system, all embodiments and variations as discussed herein can be applied. The stations may be arranged adjacent to the laboratory sample distribution system.

Pre-analytical stations may be adapted to perform any kind of pre-processing of samples, sample containers and/or sample container carriers.

Analytical stations may be adapted to use a sample or part of the sample and the reagent to generate a measuring signal, the measuring signal indicating if and in which concentration, if any, an analyte exists.

Post-analytical stations may be adapted to perform any kind of post-processing of samples, sample containers and/or sample container carriers.

The pre-analytical, analytical and/or post-analytical stations may comprise at least one of a decapping station, a recapping station, an aliquot station, a centrifugation station, an archiving station, a pipetting station, a sorting station, a tube type identification station, a sample quality determining station, an add-on buffer station, a liquid level detection station, and a sealing/desealing station.

According to an embodiment, at least an input field or an output field for one of the laboratory stations on the transport plane can be identified/marked using one of the geometric shapes.

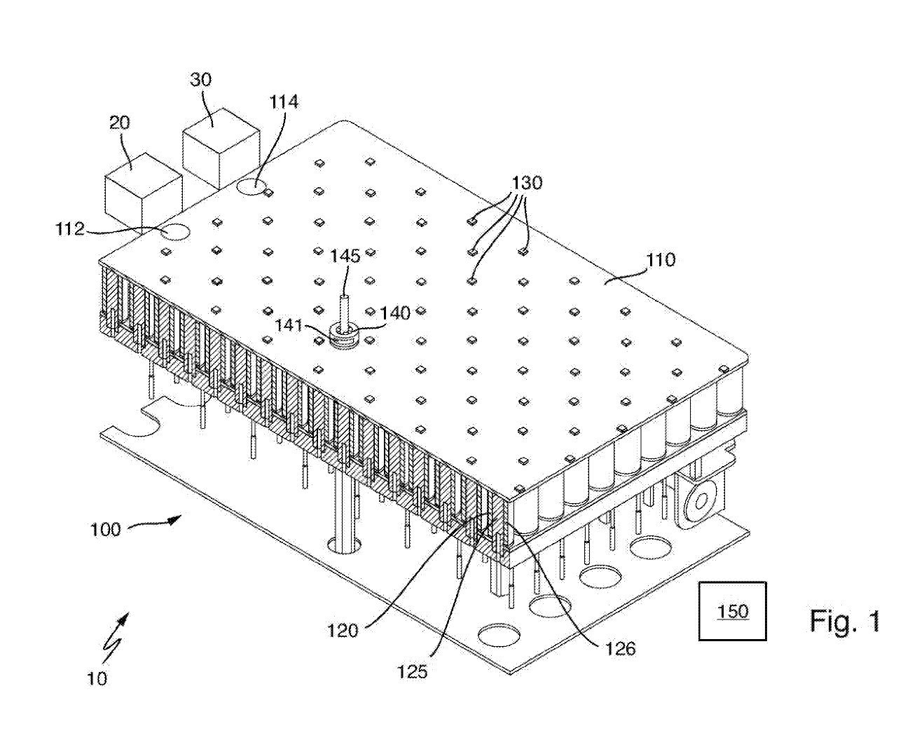

Referring initially to FIG. 1, FIG. 1 shows a laboratory automation system 10. The laboratory automation system 10 can comprise a first laboratory station 20, a second laboratory station 30 and a laboratory sample distribution system 100.

The laboratory sample distribution system 100 can comprise a transport plane 110. Below the transport plane 110, a plurality of electro-magnetic actuators 120 can be arranged in rows and columns forming a grid. Each electro-magnetic actuator 120 can comprise a respective ferromagnetic core 125 encircled by a coil 126.

A number of position sensors 130, embodied as Hall-sensors, can be distributed over the transport plane 110.

The laboratory sample distribution system 100 can further comprise a plurality of sample container carriers 140. A sample container carrier 140 can carry a respective sample container 145, embodied as laboratory tube. It can be noted that only one laboratory sample container carrier 140 carrying a respective sample container 145 is shown in FIG. 1 for exemplary purposes.

A typical sample distribution system 100 can comprise a plurality of such sample container carriers 140.

Each sample container carrier 140 can comprise a magnetically active device 141 in the form of a permanent magnet. Thus, magnetic fields generated by the electro-magnetic actuators 120 can drive a sample container carrier 140 over the transport plane 110. Furthermore, the magnetic field generated by the permanent magnet 141 of a sample container carrier 140 can be detected by the position sensors 130, so that a feedback regarding the position of a sample container carrier 140 can be obtained.

Both the electro-magnetic actuators 120 and the position sensors 130 can be electrically connected to a control device 150. The control device 150 can drive the electro-magnetic actuators 120 such that the sample container carriers 140 move along corresponding transport paths. It can also determine the position of each sample container carrier 140.

The laboratory stations 20, 30 can be arranged adjacent to the transport plane 110. It can be noted that these two laboratory stations 20, 30 are only shown for exemplary purposes in FIG. 1 and that a typical laboratory automation system 10 can comprise more than two laboratory stations 20, 30.

On the transport plane 110, a first geometric shape 112 and a second geometric shape 114 can be provided. The geometric shapes 112, 114 can be embodied as closed circles. They can be printed directly on the transport plane 110.

As shown in FIG. 1, the first geometric shape 112 can be positioned adjacent to the first laboratory station 20 and the second geometric shape 114 can be positioned adjacent to the second laboratory station 30. The geometric shapes 112, 114 can define fields that can be used as input and output fields for the laboratory stations 20, 30. In other words, these fields can be used to put sample containers 145 from the laboratory stations 20, 30 into sample container carriers 140, or vice versa. The fields can also be denoted as handover fields.

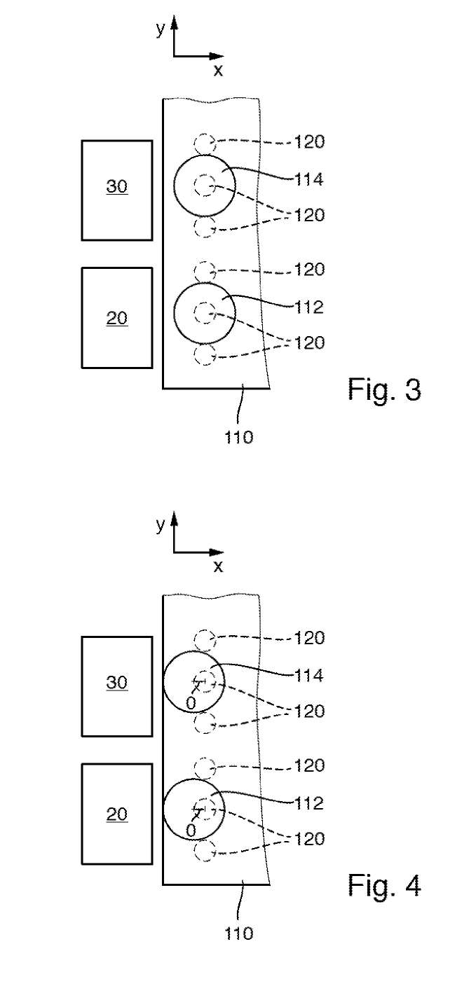

Now referring to FIG. 3 showing a schematic top view on the left part of the laboratory sample distribution system 100 of FIG. 1, the geometric shapes 112, 114 can be positioned above and coaxially with a winding axis of the coil 126 of the corresponding electromagnetic actuator 120.

Now referring to FIG. 4 showing a schematic top view on an alternative embodiment of the left part of the laboratory sample distribution system 100 of FIG. 1, the geometric shapes 112, 114 can be positioned with a horizontal offset 0 in x-direction with regard to a winding axis of the coil 126 of the corresponding electromagnetic actuator 120. This may be useful e.g. if the laboratory stations 20, 30 comprise electro-magnetic actuators applying a magnetic force to a sample container carrier 140 in order to move the sample container carrier 140 towards the laboratory stations 20, 30.

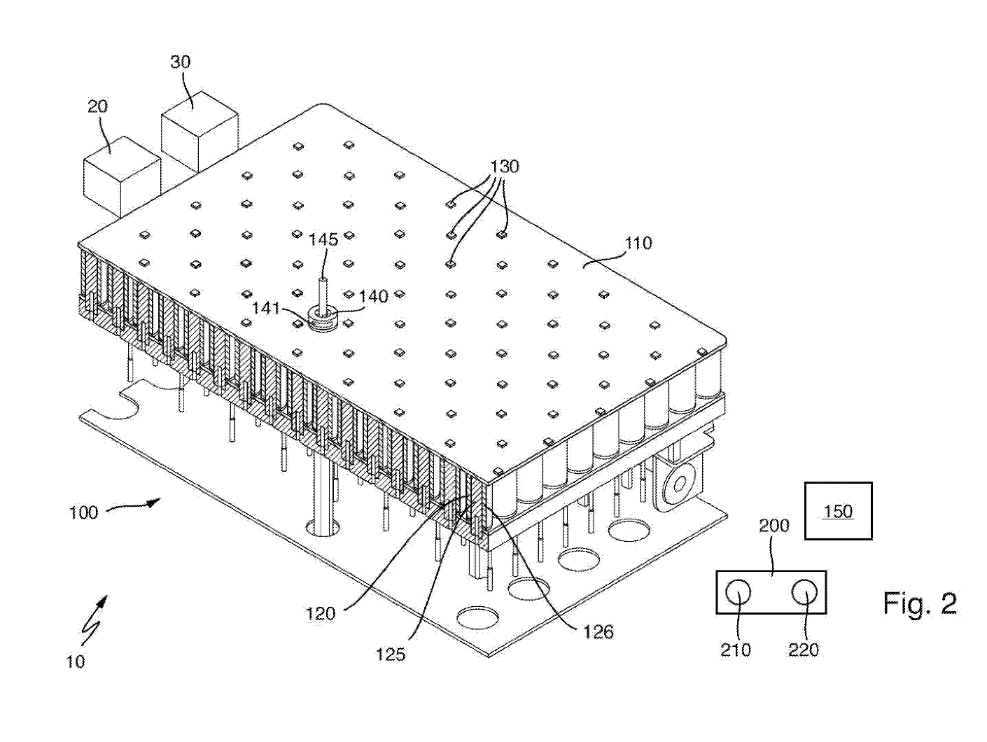

FIG. 2 shows an alternative embodiment of a laboratory automation system 10. The laboratory automation system 10 can comprise an alternative laboratory sample distribution system 100.

In the state shown in FIG. 2 no geometric shapes are printed on the transport plane 110.

The laboratory sample distribution system 100 can additionally comprise a flat template 200 that can be configured to be used in order to draw two circles on the transport plane 110. For that purpose, the flat template can have a first circular orifice 210 and a second circular orifice 220. These circular orifices 210, 220 can be configured such that geometric shapes in the form of closed circles can be drawn on the transport plane 110 similarly to the geometric shapes 112, 114 shown in FIG. 1 if the flat template 200 is placed on the transport plane 110 at a corresponding position adjacent to the laboratory stations 20, 30.

Thus, the flat template 200 can allow for the possibility that an operator can draw the geometric shapes on the transport plane 110 at his own, e.g. during a bringing into service of the laboratory automation system 10.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

I claim:

1. A laboratory sample distribution system, the laboratory sample distribution system comprising:
a transport plane;
a number of sample container carriers;
a driver configured to move the sample container carriers on the transport plane; and
a control device configured to control the movement of the sample container carriers on top of the transport plane by driving the driver such that the sample container carriers move along corresponding transport paths, wherein a number of optically recognizable geometric shapes are placed on the transport plane, each geometric shape representing a dedicated field on the transport plane.

2. The laboratory sample distribution system according to claim 1, wherein the geometric shapes are printed on the transport plane.

3. The laboratory sample distribution system according to claim 1, wherein the geometric shapes are printed on a sheet covering the transport plane.

4. The laboratory sample distribution system according to claim 1, wherein the geometric shapes are printed on a removable cover sheet which protects a sliding surface of the transport plane during transport and/or installation.

5. The laboratory sample distribution system according to claim 1, wherein a first group of the geometric shapes represents a set of input fields.

6. The laboratory sample distribution system according to claim 5, wherein a second group of the geometric shapes represents a set of output fields.

7. The laboratory sample distribution system according to claim 6, wherein the geometric shapes of the first group are rotated by 180° with respect to the geometric shapes of the second group.

8. The laboratory sample distribution system according to claim 1, wherein the geometric shapes are placed along a straight line adjacent to an edge of the transport plane.

9. A laboratory sample distribution system, the laboratory sample distribution system comprising:
a transport plane;
a number of sample container carriers;
a driver configured to move the sample container carriers on the transport plane;
a control device configured to control the movement of the sample container carriers on top of the transport plane by driving the driver such that the sample container carriers move along corresponding transport paths; and
a flat template having a plurality of holes, the holes arranged and configured for providing outlines of geometric shapes such that these geometric shapes can be drawn optically recognizably on the transport plane using the template when it is placed on the transport plane, each geometric shape drawn on the transport plane representing a dedicated field on the transport plane.

10. The laboratory sample distribution system according to claim 9, wherein the template is made of hard paper or plastic material.

11. The laboratory sample distribution system according to claim 9, wherein the geometric shapes are circles.

12. The laboratory sample distribution system according to one claim 9, wherein the driver is formed as electromagnetic actuators located below the transport plane and controllable by the control device and the sample container carriers each comprise a magnetically active device for interaction with a magnetic field generated by the electromagnetic actuators such that a magnetic drive force is applied to the sample container carriers.

13. The laboratory sample distribution system according to claim 12, wherein the geometric shapes are positioned depending on positions of the electromagnetic actuators.

14. A laboratory automation system, the laboratory automation system comprising:
a number of laboratory stations; and
a laboratory sample distribution system according to claim 1.

15. The laboratory automation system according to claim 14, wherein the number of laboratory stations are pre-analytical, analytical and/or post-analytical stations.

16. The laboratory automation system according to claim 14, wherein at least an input field or an output field for one of the laboratory stations on the transport plane is identified using one of the geometric shapes.
